(19) United States
(12) Patent Application Publication
(10) Pub. No.: US 2006/0174085 A1
(43) Pub. Date: Aug. 3, 2006

(54) Storage enclosure and method for the automated configuration of a storage enclosure

(75) Inventors: Kai Yam Wu, Austin, TX (US); Farzad Khosrowpour, Pflugerville, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/046,599

(22) Filed: Jan. 28, 2005

(51) Int. Cl. G06F 12/00

(52) U.S. Cl. 711/170

(57) ABSTRACT

An architecture and a method for the automated configuration of a storage enclosure are disclosed. The disclosed storage enclosure includes an internal communications link between the storage controllers of the storage enclosure. The storage enclosure is operable to determine if the storage enclosure is a terminal storage enclosure or if the expansion ports of the storage enclosure are externally cabled. If the storage enclosure is the terminal storage enclosure, the internal communications link is enabled, providing a communications pathway between the two controllers that is internal to the storage enclosure.

### TECHNICAL FIELD

The present disclosure relates generally to the field of networks, and, more particularly, to a topology for a cluster network that includes multiple server nodes.

### BACKGROUND

As the value and use of information continues to increase, individuals and businesses continually seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary with regard to the kind of information that is handled, how the information is handled, how much information is processed, stored, or communicated, and how quickly and efficiently the information may be processed, stored, or communicated. The variations in information handling systems allow for information handling systems to be general or configured for a specific user or specific use, including such uses as financial transaction processing, airline reservations, enterprise data storage, or global communications. In addition, information handling systems may include a variety of hardware and software components that may be configured to process, store, and communicate information and may include one or more computer systems, data storage systems, and networking systems.

Computers, including servers and workstations, are often grouped in clusters to perform specific tasks. A server cluster is a group of independent servers that is managed as a single system. Compared with groupings of unmanaged servers, a server cluster is characterized by higher availability, manageability, and scalability. A server cluster typically involves the configuration of a group of servers such that the servers appear in the network as a single machine or unit. At a minimum, a server cluster includes two servers, which are sometimes referred to as nodes and which are connected to one another by a network or other communication links. A storage network may be coupled to the server cluster. A storage network will typically include one or more storage devices that may or may not be shared by the servers of the server cluster. A storage network may include one or more storage enclosures, which may house a plurality of disk-based hard drives. A storage controller may be included within the servers of the server cluster or a storage controller may be external to the servers and included with the enclosures of the storage network.

The servers of the cluster server may communicate with the storage network according to the Serial Attached SCSI (SAS) communications protocol. Serial Attached SCSI is a storage network interface that is characterized by a serial, point-to-point architecture. In addition, the storage of a cluster network may include some element of fault tolerant storage. One example of fault tolerant storage is RAD (Redundant Array of Independent Disks) storage. RAID storage involves the organization of multiple disks into an array of disks to obtain performance, capacity, and reliability advantages.

Each server of a cluster network is sometimes identified as a node of the network. The nodes of a cluster network are directly coupled to one another to support the operational monitoring of each nodes, the sharing or failover of storage resources among the nodes in the storage network, and the configuration of the cluster network. In the event of a failure of the direct communication link, the operation of the cluster network could be compromised, as the nodes can no longer directly communicate with one another to monitor and manage the operation of the cluster network.

### SUMMARY

In accordance with the present disclosure, an architecture and a method for the automated configuration of a storage enclosure are disclosed. The disclosed storage enclosure includes an internal communications link between the storage controllers of the storage enclosure. At a reset and at a power on of the storage enclosure, the storage enclosure determines if the storage enclosure is a terminal storage enclosure or if the expansion ports of the storage enclosure are externally cabled. If the storage enclosure is the terminal storage enclosure, the internal communications link is enabled, providing a communications pathway between the two controllers that is internal to the storage enclosure.

The architecture and method disclosed herein is advantageous because it provides an alternative to the technique of coupling the storage controllers of a terminal storage enclosure to one another by an external cable. Because an external cable is not employed, the external cable cannot be misconnected or disconnected. Instead, the communications link is established internally within the backplane of the storage enclosure. Another technical advantage of the architecture disclosed herein is that the presence of an alternate internal communications link in each storage enclosure ensures that at least one storage enclosure of each cluster network will included a peer-to-peer communications link between storage controllers. The existence of such a peer-to-peer communications link can assist in the execution of failover protocols in the cluster network.

Another technical advantage of the storage enclosure architecture and method disclosed herein is that each storage enclosure of a cluster network is operable to automatically configure itself to enable the internal communications link. As such, each storage enclosure may perform an automated configuration routine to enable the internal communications link if neither of the expansion ports of the storage controllers is externally cabled. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a cluster network;

FIG. 2 is a logical view of the internal architecture of terminal storage enclosure;

FIG. 3 is a flow diagram of a series of method steps for enabling an internal communications link between the storage controllers of the storage enclosure; and

FIG. 4 is a flow diagram of a series of method steps for enabling an internal communications link on the basis of whether an external cable is connected one or both of the expansion ports of the storage controllers of the storage enclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a person computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

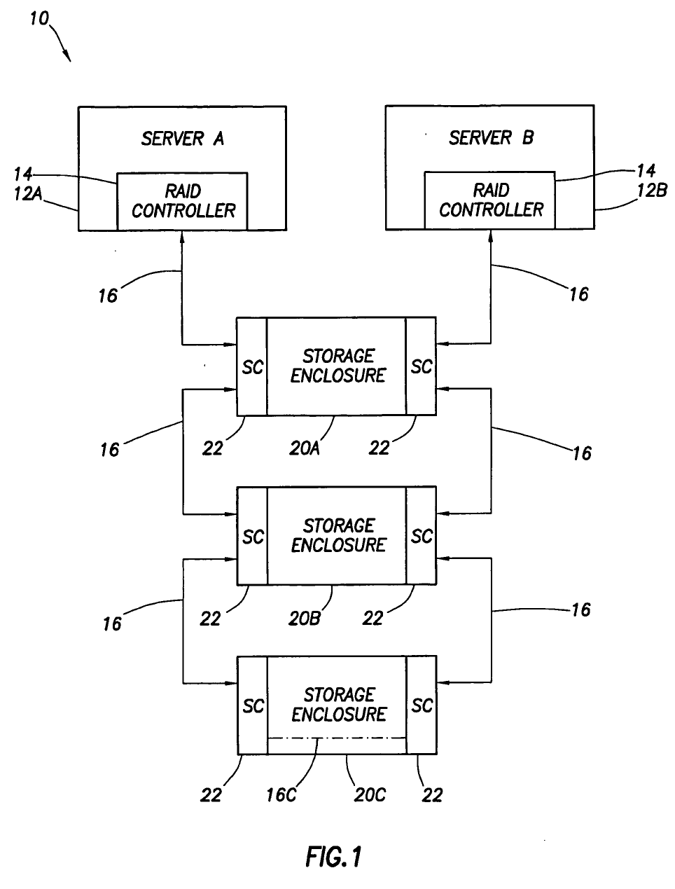

Shown in FIG. 1 is cluster network, which is indicated generally at 10. Cluster network 10 includes two servers 12 arranged as the server nodes of a server cluster. The server nodes are identified as server node A at 12a and server node B at 12b. Each server node 12 includes at least one RAID controller 14, which may be included in each server node as a card that is included in the PCI (Peripheral Component Interconnect) slot of the server node. Each server node 12 may include a storage controller, such as a RAID controller 14. RAID controller 14 manages the data accesses to the storage drives maintained in the storage enclosures of the cluster network. RAID controller 14 may also maintain a write-back cache for storing writes to the storage drives of the storage enclosures. Cluster network 10 includes a number of storage enclosures 20, which are identified individually in the example of FIG. 1 as storage enclosure 20A, storage enclosure 20B, and storage enclosure 20C. The cluster network of FIG. 1 includes RAID controllers 14 that are internal to the servers of the network. Although not shown in FIG. 1, it should be recognized that a cluster network could be configured so that the RAID controllers are external to the servers and included within the storage enclosures of the network.

The storage enclosures are arranged in a column topology. Storage enclosure 20A is coupled through communication links 16 to each server node 12. Storage enclosure 20A is sometimes referred to herein as a gateway storage enclosure because it serves as the first storage enclosure in the column of storage enclosures and is directly coupled to each of the server nodes of the network. Each of the storage controllers (SC) 22 of storage enclosure 20A is coupled to one of the server nodes 12. Storage enclosure 20B is coupled through communication links 16 to storage enclosure 20A and storage enclosure 20C. Storage enclosure 20B is sometimes referred to herein as an intermediate storage enclosure because it is coupled between two other storage enclosures. Storage enclosure 20C is a terminal storage enclosure and is coupled to storage enclosure 20B through communication links 16. Terminal storage enclosure 20C is so named because it is the final storage enclosure in the column of storage enclosures. Each storage enclosure 20 is a dual port enclosure. Each storage enclosure includes two storage controllers 22 and the storage resources of each storage enclosure may be accessed through each of the storage controllers of the storage enclosure. As shown by architectural diagram of FIG. 1, each storage controller of each storage enclosure is coupled to at least one other storage controller of another storage enclosure.

The architecture of the enclosure column is just one example of the architecture of column of storage enclosures. An enclosure column may include multiple intermediate storage enclosures 20B, or an enclosure column may also include no storage enclosures 20B. An enclosure column must include one storage enclosure that functions as a gateway enclosure and one storage enclosures that functions as a terminal enclosure. If the enclosure column includes only a single enclosure, the single enclosure is both the gateway enclosure and the terminal enclosure. Terminal enclosure 20C includes an internal communications link 16C between each of the storage controllers 22. As shown in FIG. 1, communications link 16C provides a direct and internal communications pathway between the enclosure interface controllers of the each terminal storage enclosure. The communications link 16C is not external to the storage enclosure. Rather, communications link 16C is electrically coupled to the backplane of the storage enclosure.

As indicated in the architectural diagram of FIG. 1, a communications transmission could be routed between server node 12A and server node 12B by routing the transmission through a series of storage controllers and communications link 16C. As an example, a data transmission received at a storage controller 22 of gateway storage enclosure 20A from server node 12A could be routed via a communications link 16 to a storage controller 22 of storage enclosure 20B. From storage enclosure 20B, the data transmission is routed via communications link 16 to a storage controller 22 of storage enclosure 20C. Once the data transmission is received at the storage controller 22 of the terminal storage enclosure 16C, the data transmission is transferred via the internal communications link 16C to the opposite storage controller of terminal storage enclosure 16C. Data received by the opposite storage controller of terminal storage enclosure 20C is then routed through the storage controller of the intermediate storage enclosure 20B and on to the storage controller of storage enclosure 20A. From storage controller of storage enclosure 20A, the communication can be transmitted via communications link 16 to server node 12B. In this example, the existence of the internal communications link between the storage controllers of storage enclosure 20C eliminates the need for an external communications link between these storage controllers.

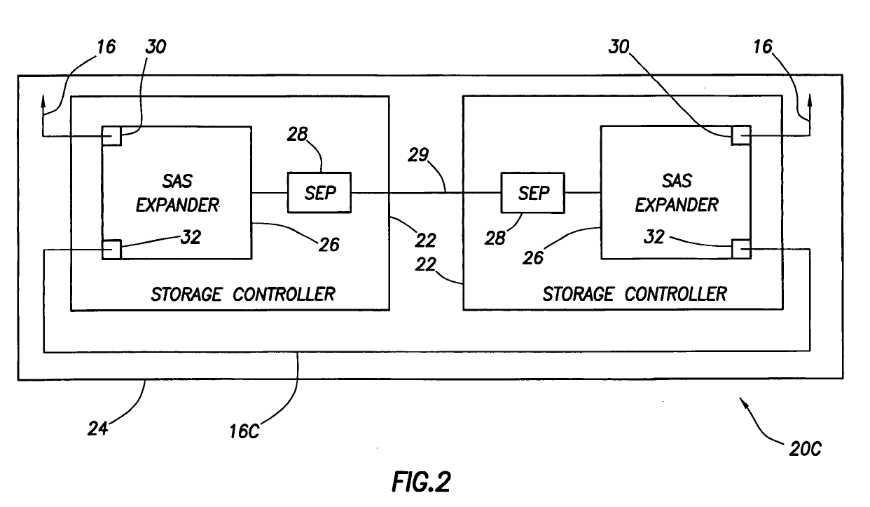

Shown in FIG. 2 is a logical view of the internal architecture of terminal storage enclosure 20C. Terminal storage enclosure 20C includes an electrical backplane 24. Coupled to backplane 24 are each of the storage controllers 22 of the storage enclosure. Each storage controller 22 includes a storage enclosure processor (SEP) 28. Each of the storage enclosure processors are coupled to one another through a communications link 29. Each storage controller 22 also includes an SAS expander 26, and each SAS expander 26 of FIG. 2 includes two ports. It will be recognized that an SAS expander can have more than two ports. One of the ports of each SAS expander is a primary port 30 and the other part of each SAS expander is an expansion port 32. Depending on the precise architecture of the network, each primary port 30 is coupled via communications link to the primary port of an SAS expander of an adjacent storage enclosure or server node. In the architecture of the storage enclosure of FIG. 2, the expansion ports 32 of each SAS expander 32 are coupled to one another via a communications link 16C. Communications link 16C is internal to storage enclosure 20C and is electrically coupled to the backplane 24 of the storage enclosure. A terminal storage enclosure, such as enclosure 20C, has expansion ports that are each not coupled to the primary ports of another storage enclosure.

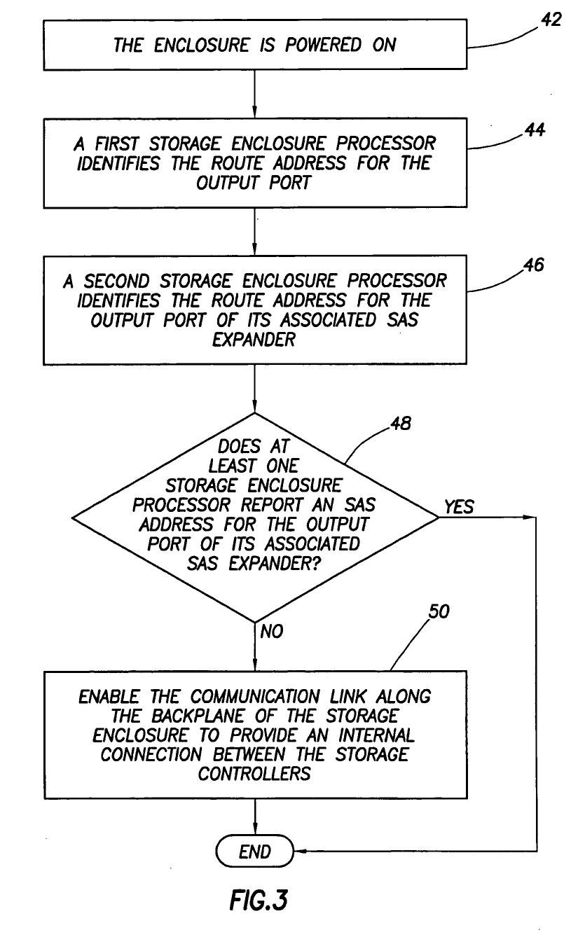

Shown in FIG. 3 is a flow diagram of a series of method steps for configuring a storage enclosure to enable an internal communications link between the storage controllers of the storage enclosure. At step 42, the storage enclosure is powered on or initiated. As part of a reset event at the storage enclosure, the storage enclosure determines if it is a terminal enclosure in the network architecture. A reset event could include a boot or power-up of the storage enclosure. If a storage enclosure determines that it is a terminal storage enclosure in the network, the internal communications link between the expansion ports of the storage controllers of the storage enclosure is enabled. At step 42, a first storage enclosure processor of the two storage enclosure processors in the storage enclosure identifies the route address of the expansion port 32 associated with the SAS expander coupled to the first storage enclosure processor. By identifying the route address of the expansion port, the storage enclosure processor determines if the expansion port is coupled to an expansion point having a valid SAS address. If the first storage enclosure processor identifies that the expansion port is coupled to a valid SAS address, the expansion port is coupled to the primary port of an SAS expander of an adjacent storage enclosure. At step 44, the identification of the route address of the expansion port is performed with respect to the second of the two storage enclosure processors and associated SAS expanders of the storage enclosure.

At step 48, it is determined if at least one of the storage enclosure processors of the storage enclosures identified an SAS address as the route address for the expansion port for the SAS expander associated with the storage enclosure processor. If both or one of the storage enclosure processors identified a SAS address as the route address for the expansion port, the expansion port or expansion ports associated with the route address is coupled to an primary port of an adjacent storage enclosure, and the storage enclosure is not a terminal storage enclosure. Following the determination that both or one of the storage enclosure processors identified an SAS address as the route address for the expansion port, the flow diagram ends. If, however, neither of the storage enclosure processors identifies an SAS address as the route address for the expansion port of the associated SAS expander, the storage enclosure is a terminal storage enclosure and the internal communications link between the storage controllers is enabled, providing a communications link between the storage controllers that is internal to the storage controller and is supported by the backplane of the storage enclosure. As a result of executing the steps of FIG. 3, each storage enclosure of the network can automatically configure itself to enable an internal communications link between storage controllers of the storage enclosure if it is determined that the storage enclosure is the terminal storage enclosure.

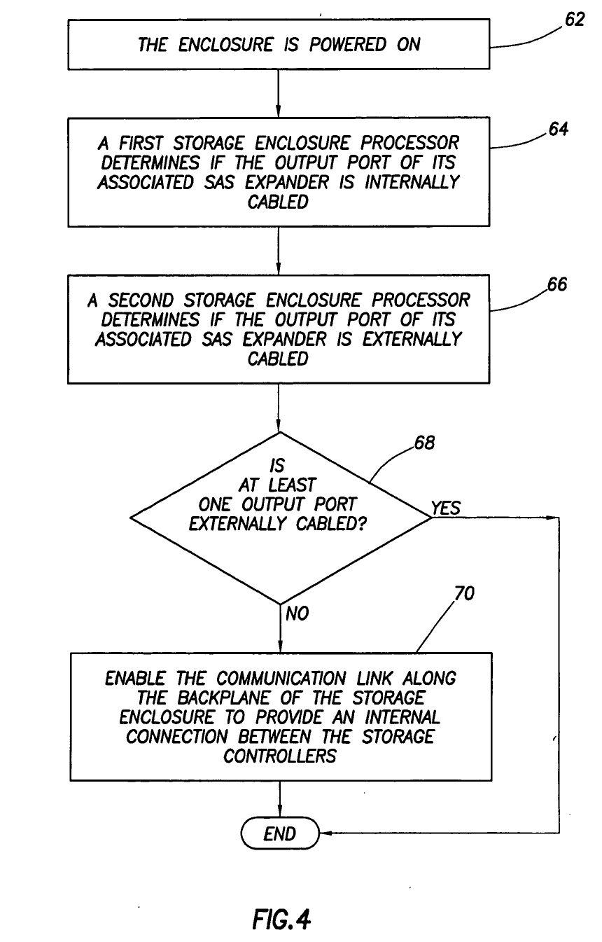

Shown in FIG. 4 is a flow diagram of a series of method steps for enabling the internal communications link on the basis of whether an external cable is connected one or both of the expansion ports of the SAS expanders of the storage enclosure. At step 62, the selected enclosure is powered on or otherwise reset to initiate the evaluation and automated configuration process of FIG. 4. At step 64, a first storage enclosure processor determines if the expansion port of the associated SAS expander is externally cabled. A determination of whether the expansion port is externally cabled can be made on the basis of an analysis of the electrical signals of the pins of the expansion port. Similarly, at step 66, the second storage enclosure processor of the storage enclosure determines if the expansion port of the associated SAS expander is externally cabled. At step 68, it is determined if at least one of the expansion ports of the storage enclosure is externally cabled. If one of the expansion ports of the storage enclosure is externally cabled, the externally cabled expansion port or expansion ports is coupled to another storage enclosure. If it is determined that one or both of the expansion ports is externally cabled, it could also be possible for the expansion ports of the storage enclosure to be coupled to one another through a wrap-around communications link between the two expansion ports of the storage enclosure. If it is determined that at least one of the expansion ports is externally cabled, the flow diagram of FIG. 4 ends, as there is not a need to enable the internal communications link between the storage controllers of the storage enclosure.

If it is determined at step 66 that at least one of the expansion ports of the storage enclosure is not externally cabled, the internal communications link of the storage enclosure is enabled to provide a direct, internal communication path between the expansion ports of the storage controllers of the storage enclosure. As described, this communication link is electrically coupled to and supported through the backplane of the storage enclosure. The method of FIG. 4 provides a technique for the automated configuration of each storage enclosure of the network. Each storage enclosure is automatically configured such that the internal communications link is enabled on the basis of whether an external cable is not present at each expansion port of the storage enclosure. As such, the terminal enclosure of the network could be automatically configured to provide an internal communications link between the storage controllers by removing the external cabling and initiating the configuration process that is set out in FIG. 4.

The architecture and method disclosed herein ensures the presence of at least one peer-to-peer communications link between the storage controllers of each storage enclosure of the network. In addition to the automated configuration techniques described above, it is also recognized that the internal communications link of a selected storage enclosure could be enabled by a user to initiate an internal communications pathway between the storage controllers. It should be recognized that the methodology disclosed herein may be employed in any number of cluster server architectures. For example, the technique described herein may be employed in a cluster network having fewer or more than three storage enclosures. As an example, a storage column could include two storage enclosures, with the first storage enclosure being identified as the gateway storage enclosure and the other storage enclosure being identified as the terminal storage enclosure. The architecture and method disclosed herein is not limited in its use to networks that employ the SAS communications protocol. Rather, the architecture and method disclosed herein may be used with any network that employs a point-to-point topology. Although the present disclosure has been described in detail, it should be understood that various changes, substitutions, and alterations can be made hereto without departing from the spirit and the scope of the invention as defined by the appended claims.

What is claimed is:

1. A cluster network, comprising:
a first server node;
a second server node;
a storage enclosure, wherein the storage enclosure includes first and second storage controllers,
wherein the first storage controller of the storage enclosure is communicatively coupled through external cabling to the first server node;
wherein the second storage controller of the storage enclosure is communicatively coupled through external cabling to the second server node; and
wherein the first storage controller is coupled to the second storage controller through a communications link that is internal to the storage enclosure.

2. The cluster network of claim 1, wherein the internal communication link between the first storage controller and the second storage controller of the storage enclosure is electrically coupled to the backplane of the storage enclosure.

3. The cluster network of claim 1, wherein the storage enclosure is a terminal storage enclosure.

4. The cluster network of claim 1, wherein a primary port of each of the storage controllers of the storage enclosure is coupled to an expansion port of the second storage enclosure through an external connection.

5. The cluster network of claim 1, wherein a primary port of the first storage controller is coupled to the first server node through an external cable connection and wherein a primary port of the second storage controller is coupled to the second server node through an external connection.

6. The cluster network of claim 1,
wherein a primary port of each of the storage controllers of the storage enclosure is coupled to an expansion port of the second storage enclosure through an external connection; and
wherein the internal communication link between the first storage controller and the second storage controller of the storage enclosure is electrically coupled to the backplane of the storage enclosure.

7. The cluster network of claim 1,
wherein a primary port of the first storage controller is coupled to the first server node through an external cable connection and wherein a primary port of the second storage controller is coupled to the second server node through an external connection; and
wherein the internal communication link between the first storage controller and the second storage controller of the storage enclosure is electrically coupled to the backplane of the storage enclosure.

8. The cluster network of claim 1, wherein each of the first server node and the second server node include a RAID controller.

9. The cluster network of claim 1, wherein the storage enclosure includes a RAID controller.

10. A method for establishing an internal communications link between the storage controllers of a storage enclosure, comprising:
determining whether the storage enclosure is a terminal storage enclosure; and
enabling an internal communications link between the storage controllers of the storage enclosures, whereby the storage controllers are operable to transmit data to and from one another without the use of an external connection.

11. The method for establishing an internal communications link between the storage controllers of a storage enclosure of claim 10, wherein the step of determining whether the storage enclosure is a terminal storage enclosure comprises the step of determining if the expansion port of each expander of each storage controller is not coupled to an external address.

12. The method for establishing an internal communications link between the storage controllers of a storage enclosure of claim 11,
wherein the storage enclosure is determined to be a terminal storage enclosure if the expansion port of each of the expanders is not coupled to an external address; and
wherein the storage enclosure is determined to not be a terminal storage enclosure if at least one expansion port of each of the expanders is coupled to an external address

13. The method for establishing an internal communications link between the storage controllers of a storage enclosure of claim 12, wherein the communications link is electrically coupled to the backplane of the storage enclosure.

14. The method for establishing an internal communications link between the storage controllers of a storage enclosure of claim 10, wherein the step of determining whether the storage enclosure is a terminal storage enclosure comprises the step of determining if the expansion port of each expander of each storage controller is physically coupled to an external cable.

15. The method for establishing an internal communications link between the storage controllers of a storage enclosure of claim 14, wherein the step of determining if the expansion port of each expander of each storage controller is physically coupled to an external cable comprises the step of determining if a predetermined signal is present at the expansion port of each expander.

16. The method for establishing an internal communications link between the storage controllers of a storage enclosure of claim 15, wherein the communications link is electrically coupled to the backplane of the storage enclosure.

17. A method for establishing an internal electrical connection between two storage controllers of a storage enclosure, comprising:
determining if at least one of the storage controllers of the storage enclosure is coupled through an external cable to a storage enclosure of a server node; and
enabling the internal communications link between the storage controllers of the storage enclosure if it is determined that neither of the storage controllers of the storage enclosure is coupled externally to a storage enclosure or a server node.

18. The method for establishing an internal electrical connection between two storage controllers of a storage enclosure of claim 17, wherein the step of determining if at least one of the storage controllers of the storage enclosure is coupled through an external cable to a storage enclosure or a server node comprises the step of determining if the expansion port of each SAS expander is coupled to an SAS address.

19. The method for establishing an internal electrical connection between two storage controllers of a storage enclosure of claim 18, wherein the internal electrical connection between the two storage controllers of the storage enclosure is electrically coupled to the backplane of the storage enclosure.

20. The method for establishing an internal electrical connection between two storage controllers of a storage enclosure of claim 17, wherein the step of determining if at least one of the storage controllers of the storage enclosure is coupled through an external cable to a storage enclosure or a server node comprises the step of determining if a predetermined electrical signal is present at the expansion port of each SAS expander of each storage controller.

21. The method for establishing an internal electrical connection between two storage controllers of a storage enclosure of claim 20, wherein the internal electrical connection between the two storage controllers of the storage enclosure is electrically coupled to the backplane of the storage enclosure.

22. The method for establishing an internal electrical connection between two storage controllers of a storage enclosure of claim 17, wherein the determining step is performed as part of a configuration step following a reset of the storage enclosure.
